(19) United States
(12) Patent Application Publication
(10) Pub. No.: US 2006/0118995 A1
(43) Pub. Date: Jun. 8, 2006

(54) Method of manufacturing hook fasteners

(75) Inventor: Kuo Yen Cheng, Hemei Town (TW)

Correspondence Address: TROXELL LAW OFFICE PLLC;SUITE 1404, 5205 LEESBURG PIKE, FALLS CHURCH, VA, 22041, US

(73) Assignee: Spring Rich Litmited

(21) Appl. No.: 11/086,330

(22) Filed: Mar. 23, 2005

(30) Foreign Application Priority Data
Dec. 8, 2004 (TW) 093137908

(51) Int. Cl. B29C 47/00

(52) U.S. Cl. 264/167; 264/177.1; 264/177.17; 264/237

(57) ABSTRACT

A method of manufacturing hook fasteners comprises a rotatable die wheel equipped with a water channel at the interior therein for cooling thereof via water flow, and a multiplicity of hook-shaped cavities disposed at the circumferential surface thereon wherein at both opposite sides of the die wheel are respectively situated an extrusion apparatus and a cooling device, and the extrusion apparatus is applied to extrude molding material like molten plastics via a set of upper and lower nozzle sections situated close to the circumferential surface of the die wheel and adjustably moved back or forth along with the extrusion apparatus so as to determine the thickness of base portions of hook members to be molded thereby. Therefore, molding material extruded from the extrusion apparatus is accurately filled into the hook-shaped cavities of the die wheel without other pressure wheel oppositely rotating relative to the die wheel as shown in a conventional molding method. Besides, via the aforementioned method, the extruded molding material can maintain sufficient molten temperature for direct and complete injection to the hook-shaped cavities thereof before properly cooled and solidified via the cooling device and uniformly removed from the hook-shaped cavities in the final molded form of the hook members, efficiently reducing the rate of defectiveness thereof.

### BACKGROUND OF THE INVENTION

The present invention is related to a method of manufacturing hook fasteners, comprising a rotatable die wheel equipped with a water channel at the interior therein for cooling thereof via water flow, and a multiplicity of hook-shaped cavities disposed at the circumferential surface thereon wherein at both opposite sides of the die wheel are respectively situated an extrusion apparatus and a cooling device, and the extrusion apparatus can extrude molding material like molten plastics directly into the hook-shaped cavities of the die wheel without other pressure wheel applied thereto, economically omitting the use of a pressure wheel in a conventional molding method and facilitating the molding material to maintain sufficient molten temperature for direct and complete injection into the hook-shaped cavities thereof before properly cooled and solidified into molded hook members to be uniformly removed there-from so that the rate of defectiveness thereof can be efficiently reduced thereby.

Please refer to FIGS. 1 to 3 inclusive. A conventional method of manufacturing hook fasteners includes a die wheel 10, a pressure wheel 20, and an extrusion apparatus 30 situated between the die wheel 10 and the pressure wheel 20 to extrude molding material of molten plastics 40 via a extrusion nozzle 31 thereby. The die wheel 10 and the pressure wheel 20, axially in parallel, are mounted onto a support frame 11 and synchronically rotated in opposition directions. The die wheel 10 is made up of a hollow rolling tube 12 forming a water flow channel 13 therein for cooling off the die wheel 10 thereby and rotating relative to a driving support axle 14 that, having a non-illustrated cooling channel disposed therein communicating with the interior of the rolling tube 12 thereof, is retained by the support frame 11 so as to situate the die wheel 10 closely adjacent to the extrusion nozzle 31 of the extrusion apparatus 30 thereby. The die wheel 10 is also equipped with a multiplicity of hook-forming cavities 15 disposed at the circumferential surface thereon, and the pressure wheel 20, held in place via the support frame 11 and rotated by a driving axle 21, works in synchronism with the die wheel 10 in the molding of hook members 50 thereof. The pressure wheel 20 requires sufficient cooling off to prevent the molding material 40 from sticking to its circumferential surface thereon. Meanwhile, the driving axle 21 can be made of an air-pressure cylinder that can be applied to adjust the position of the pressure wheel 20 as desired via the reduction of pressure so as to change the thickness of base portions 51 of the hook members 50 as shown in FIG. 3. The pressure wheel 20 is relatively rotated with the die wheel 10 in opposite directions so as to guide the molding material 40 extruded from the extrusion nozzle 31 into the pressure gap between the die wheel 10 and the pressure wheel 20 for injection into the hook-forming cavities 15 as shown in FIG. 2. A trimming roller 16 is positioned right over the die wheel 10 towards which the molded hook members 50 are drawn by a non-illustrated a take-up roller before moving further along the trimming roller 16 for collection thereof.

There are some drawbacks to such conventional method of manufacturing hook fasteners. First, the molding material 40 depends on the relative rotation of both die wheel 10 and the pressure wheel 20 in opposite directions for smooth guidance into the hook-forming cavities 15 therein, which, complicatedly taking a lot of components in the process thereof, is uneconomically inconvenient and time-consuming in the assembly thereof. Second, the molding material 40 is pressed into the hook-forming cavities 10 in the relative rotation of the die wheel 10 and the pressure wheel 20 thereof. In case the die wheel 10 and the pressure wheel 20, not properly adjusted, are spaced apart in a rather wide distance there-between, the molding material 40 under insufficient pressure is hard to fill in each hook-forming cavity 15 in an accurate and uniform manner as shown in A of FIG. 2. Thus, half-made and incomplete projections 52 of the hook members 50 as shown in FIG. 3 can be easily molded in the method thereof, which inevitably increases the defective rate thereof. Third, the extruded molding material 40 tends to gather at the upper section of the die wheel 10 and the pressure wheel 20 and becomes an accumulation section 41 as shown in FIG. 2. Once occupying too much space or solidifying without molten in time, the accumulation section 41 not only will space the die wheel 10 and the pressure wheel 20 further apart, but also can hinder the molting material 40 from filling completely into the hook-forming cavities 15 thereof, which can result in a defective and unstable molding process and reduce the quality of the hook members obtained thereby.

Please refer to FIGS. 4 through 5 showing a U.S. Pat. No. 5,690,875. A second conventional method of manufacturing hook fasteners comprises an extrusion nozzle 10′ having an arcuate surface 11′ defining one end thereof and spaced in a proper distance from the circumferential surface of a die wheel 20′ for the molding of base portions 31′ of hook members 30 into a predetermined thickness thereby. The molded hook members 30′ are cooled and solidified gradually in a natural manner while pulled and drawn via a set of upper and lower rollers 21′, 22′ to remove from hook-member-forming cavities 23′ disposed at the circumferential surface of the die wheel 20′ thereof.

There are some disadvantages to the second conventional method of manufacturing hook fasteners. First, the molded hook members 30′ are gradually cooled and solidified in a natural manner while drawn and removed from the hook-member-forming cavities 23′ via the upper and lower rollers 21′, 22′ thereof. And to prevent the unduly deformation of the still unhardened hook members 30′ by the upper and lower rollers 22′ thereof, the conveying distance the molded hook members 30 move from the die wheel 20′ to the upper roller 21, the lower rollers 22′, and guide rollers 24′ is lengthened, which not only prolongs the time of molding thereof to an increase of cost, but also takes a lot of space to accommodate the molding apparatus thereof. Second, when the molding material 12′ is to be removed from the hook-element-forming cavities 23′ of the die wheel 20′, parts of the still hot and unhardened molding material 12′ tend to remain and stick to the interior of the hook-element-forming cavities 23′ therein without being removed uniformly there-from, which can easily come up with half-made and incomplete projections 32′ of the molded hook members 30′ and, thus, increase the rate of defectiveness thereof. Third, the extrusion nozzle 10′ is shaped with an arcuate surface 11′ spaced from the circumferential surface of the die wheel 20′ at a proper distance to determine the thickness of base portions 31′ of the hook members 30′ thereof. Over long time of use, the molding material 12′ keeps attaching to the arcuate surface 11′ of the die wheel 10′ and becomes hardened into tiny grains to destroy the smooth facet of the arcuate surface 11′ thereof and make the base portions 31′ of the molded hook members 30′ full of rough and tiny pores at the surface thereon, which not only mars the quality of the molded hook members 30′ but also influence the smooth rotation of the die wheel 20′ thereof.

### SUMMARY OF THE PRESENT INVENTION

It is, therefore, the primary purpose of the present invention to provide a method of manufacturing hook fasteners, comprising an extrusion apparatus situated facing to a rotatable die wheel equipped with a water flow channel at the interior therein, and a cooling device located at the other side of the die wheel opposite to the extrusion apparatus for immediate cooling off thereof wherein molding material like molten plastics is directly filled into hook-shaped cavities disposed at the circumferential surface of the die wheel thereon and properly chilled by the abovementioned cooling means without other pressure wheel applied thereto, economically omitting the pressure wheel of the conventional molding method and reducing the cost of production to provide a simplified molding apparatus with the minimum space occupied.

It is, therefore, the second purpose of the present invention to provide a method of manufacturing hook fasteners wherein the molding material extruded from the extrusion apparatus is accurately contacted with the circumferential surface of the die wheel and the hook-shaped cavities thereof, which can help to maintain sufficient molten temperature of the extruded molding material for direct and complete filling into the hook-shaped cavities thereof. And after properly cooled and hardened via the cooling device thereof, the molding material filled in the hook-shaped cavities thereof is uniformly removed there-from in the final molded form without any remains stayed therein to provide high-quality hook members with complete hooked projections thereof, efficiently reducing the rate of defectiveness.

It is, therefore, the third purpose of the present invention to provide a method of manufacturing hook fasteners wherein the extrusion apparatus is simply moved back or forth to adjust the space apart from the die wheel so as to determine the thickness of base portions of the hook members to be molded, facilitating an easy and speedy operation thereof. Besides, the extrusion apparatus is equipped with an upper nozzle section situated rather close to the circumferential surface of the die wheel so as to prevent the extruded molding material from over-accumulation without being molten, and the remains of the molding material from sticking to a lower nozzle section thereon and thus hindering the rotation of the die wheel thereof, facilitating a more smooth and stable molding method of manufacturing high-quality hook members obtained thereby.

### BRIEF DESCRIPTION OF THE DRAWINGS

FIG. 1 is a cross sectional view of a conventional molding method and apparatus thereof.

FIG. 2 is an enlarged partial view of molding material filling into hook-forming cavities of a die wheel according to FIG. 1.

FIG. 3 is an enlarged partial view of molded hook members according to FIG. 2.

FIG. 4 is a sectional view of another conventional molding method and apparatus as disclosed in U.S. Pat. No. 5,690,875.

FIG. 5 is an enlarged partial view of molding material filling into hook-forming cavities of a die wheel according to FIG. 4.

FIG. 6 is a sectional view of the molding method and apparatus of the present invention.

FIG. 7 is an enlarged partial view of molding material filling into hook-shaped cavities of a die wheel of the present invention.

FIG. 8 is an enlarged partial view of molded hook members of the present invention equipped with single hooked projections.

FIG. 9 is an enlarged partial view of molded hook members of the present invention equipped with double-hooked projections.

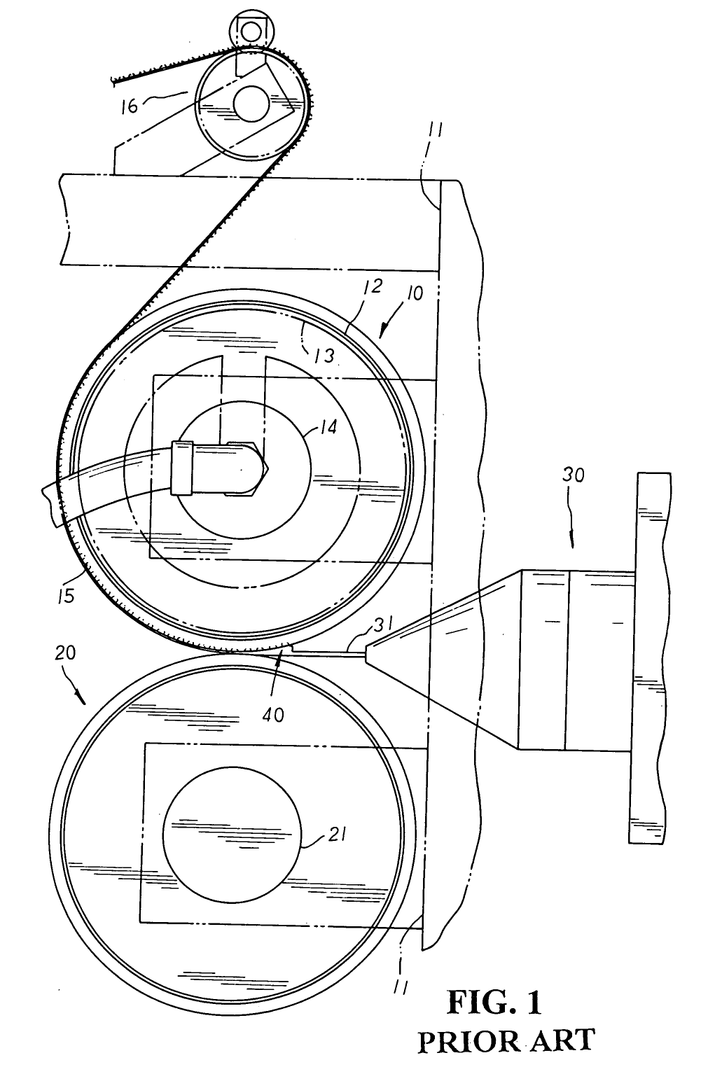

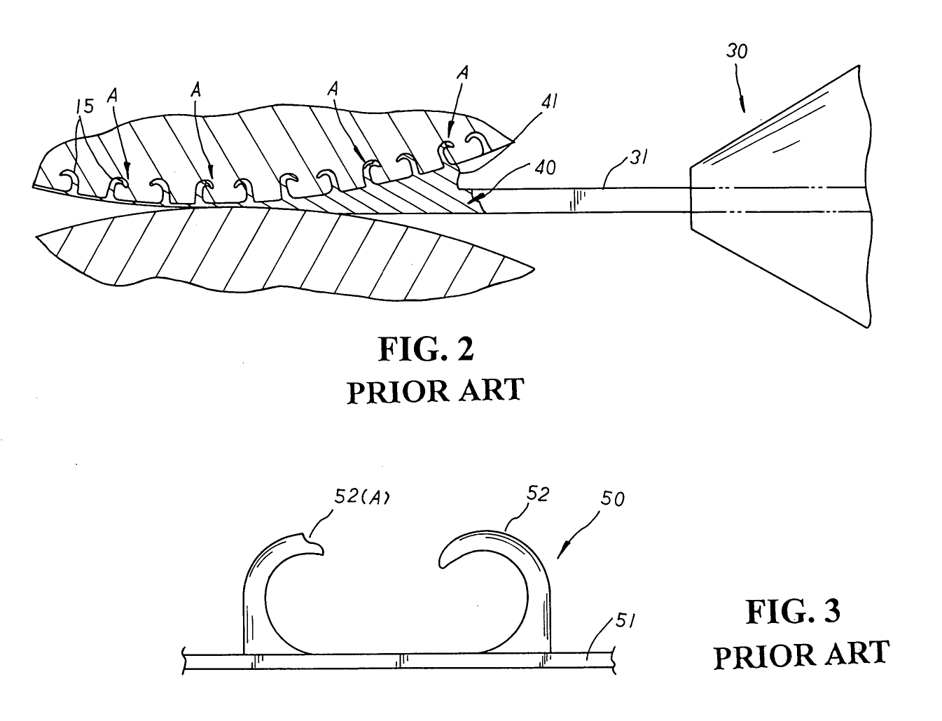

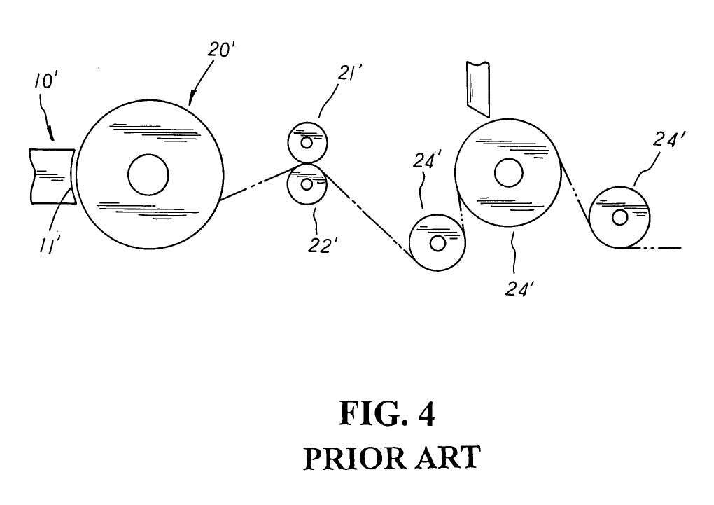

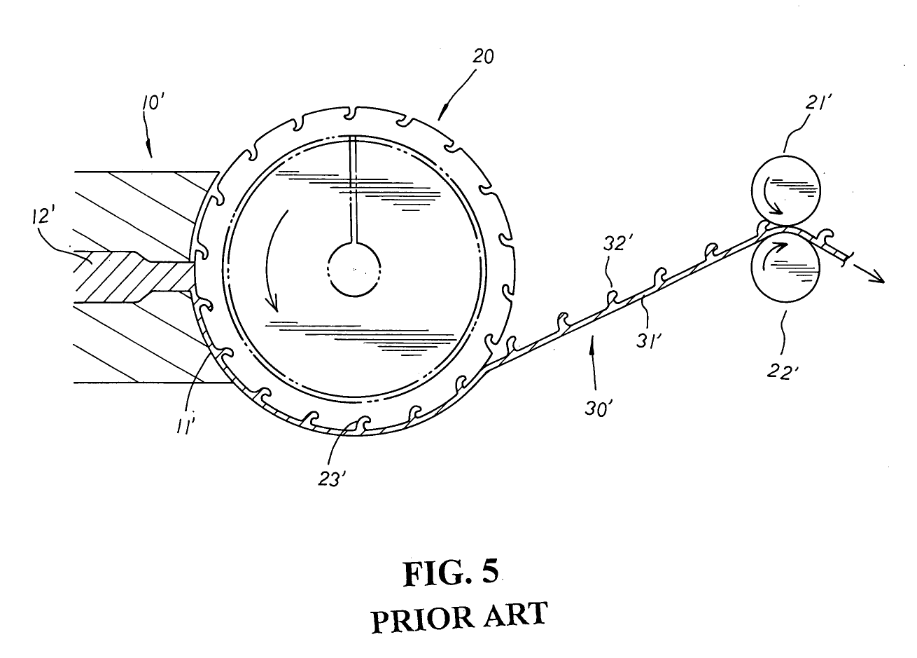

### DETAILED DESCRIPTION OF THE PREFERRED EMBODIMENTS

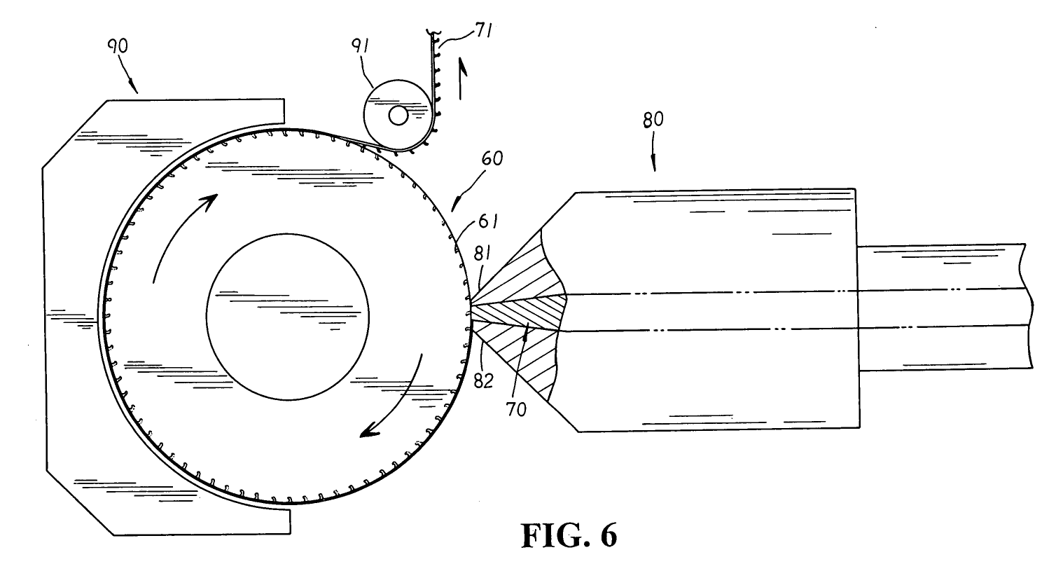

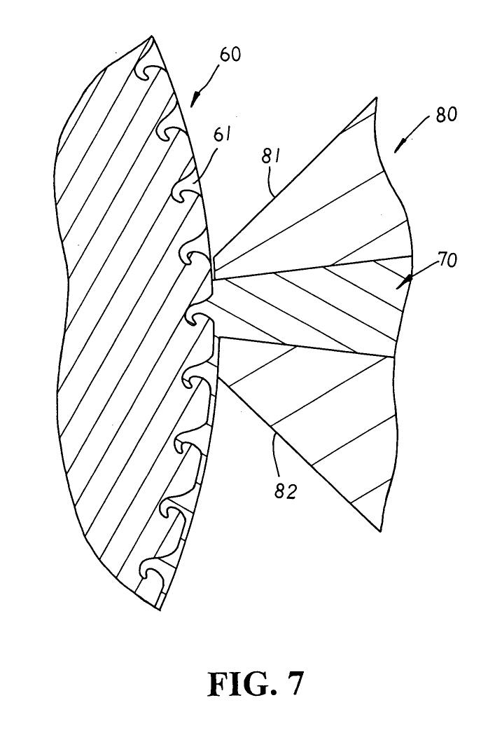

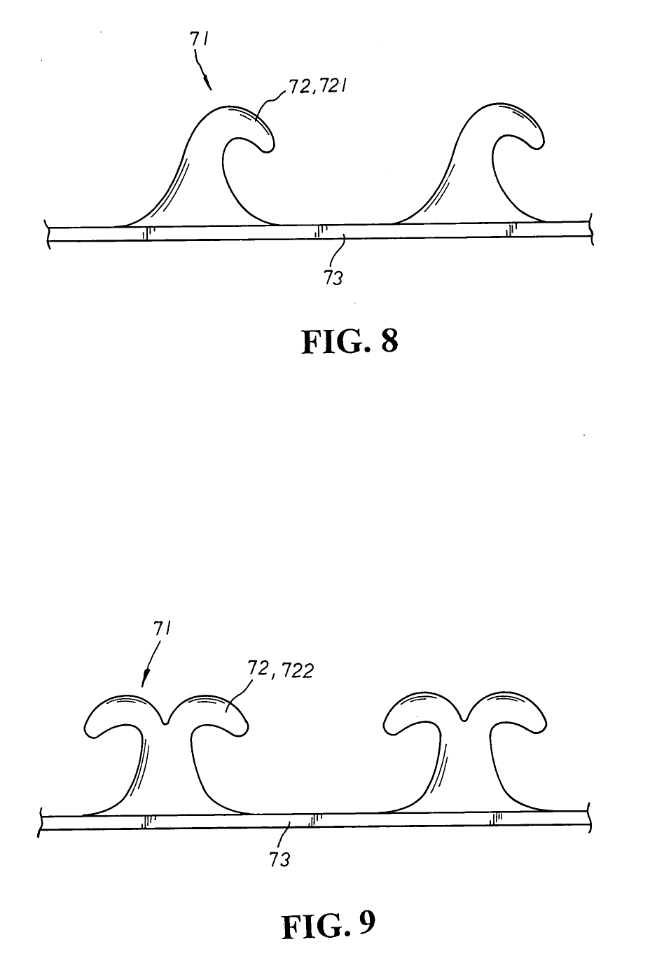

Please refer to FIGS. 6 to 7 inclusive. The present invention is related to a method of manufacturing hook fasteners, comprising a rotatable die wheel 60 equipped with a non-illustrated water channel disposed at the interior therein for cooling thereof via water flow, and a multiplicity of hook-shaped cavities 61 disposed at the circumferential surface thereon wherein the hook-shaped cavities 61 can be alternatively made in either single-hooked or double-hooked shapes in conformance with the final form of intended hook members 71, providing the hook members with projections 72 of either single-hooks 721 as shown in FIG. 8 or double-hooks 722 as shown in FIG. 9 respectively. An extrusion apparatus 80 and a cooling device 90 are respectively situated at the opposite sides of the die wheel 60 wherein the extrusion apparatus 80, serving to extrude molding material 70 like molten plastics there-from, is equipped with an upper nozzle section 81 closely approaching the circumferential surface of the die wheel 60 thereof and a lower nozzle section 82 properly spaced from the die wheel 60 at a distance, which are adjustably moved back and forth along with the extrusion apparatus 80 so as to determine the thickness of base portions 73 of the hook members 71 thereby and prevent the extruded molding material 70 from over-accumulating at the upper nozzle section 81 thereof. Therefore, the molding material 70 extruded from the extrusion apparatus 80 is accurately contacted with the circumferential surface of the die wheel 60 and the hook-shaped cavities 61, which can help to maintain sufficient molten temperature of the extruded molding material 70 for direct and complete filling into the hook-shaped cavities 61, facilitating a more smooth and stable molding method of manufacturing high-quality hook members 71 obtained thereby. Meanwhile, the cooling device 90 works in synchronism with the rotation of the die wheel 60 accordingly. And after cooled and solidified via the cooling device 90, the molded hook members 71 with the hooked projections 72 and the base portions 73 and revolving along the die wheel 60 thereon are pulled from the hook-shaped cavities 61 via non-illustrated take-up rollers and moved upwards along a guide roller 91 situated above the die wheel 60 to be wound up for collection thereof. The guide roller 91 is preferably located above one side of the die wheel 60 and properly spaced at a predetermined distance there-from, permitting the molded hook members 71 to be uniformly removed from the hook-shaped cavities 61 in the continuous rotation of the die wheel 60 thereof.

What is claimed is:

1. A method of manufacturing hook fasteners, comprising a rotatable die wheel equipped with a water channel at the interior therein for cooling thereof via water flow, and a multiplicity of hook-shaped cavities disposed at the circumferential surface thereon wherein at both opposite sides of the die wheel are respectively situated an extrusion apparatus and a cooling device, and the extrusion apparatus is applied to extrude molding material like molten plastics via a set of upper and lower nozzle section approaching the circumferential surface of the die wheel and adjustably moved back and forth along with the extrusion apparatus so as to determine the thickness of base portions of hook members to be molded thereby; therefore, molding material extruded from the extrusion apparatus is accurately contacted with the circumferential surface of the die wheel and the hook-shaped cavities thereof, which can help maintain sufficient molten temperature of the extruded molding material for direct and complete filling into the hook-shaped cavities thereby, facilitating a more smooth and stable molding method of manufacturing high-quality hook members obtained thereby; meanwhile, the cooling device works in synchronism with the rotation of the die wheel accordingly, and, after cooled and solidified via the cooling device thereof, the molded hook members with the hooked projections and the base portions and revolving along the die wheel are pulled from the hook-shaped cavities via take-up rollers and moved upwards along a guide roller situated above the die wheel to be wound up for collection thereof; the guide roller is preferably located above one side of the die wheel and properly spaced at a predetermined distance there-from, permitting the molded hook members to be uniformly removed from the hook-shaped cavities in the continuous rotation of the die wheel thereof.

2. The method of manufacturing hook fasteners according to claim 1 wherein the hook-shaped cavities of the die wheel are alternatively made in either single-hook or double-hook shapes in conformance with the final form of the intended hook members with single-hooked projections or double-hooked projections respectively.

3. The method of manufacturing hook fasteners according to claim 1 wherein the upper nozzle section of the extrusion apparatus is situated rather close to the circumferential surface of the die wheel, and the lower nozzle section thereof is properly spaced from the die wheel at a distance so as to prevent the extruded molding material from over-accumulating at the upper nozzle section thereof.
